(19) United States
(12) Patent Application Publication
(10) Pub. No.: US 2024/0375072 A1
(43) Pub. Date: Nov. 14, 2024

(54) WELLSITE METHANE PYROLYZER AND WELLSITE METHANE PYROLYSIS ALTERNATIVE TO FLARING

(71) Applicant: Nuovo Pignone Tecnologie - S.r.l., Florence (IT)

(72) Inventor: Rocco DIFOGGIO, Houston, TX (US)

(21) Appl. No.: 18/686,613

(22) PCT Filed: Aug. 26, 2022
(86) PCT No.: PCT/EP2022/025395

§ 371 Date: Feb. 26, 2024

(30) Foreign Application Priority Data
Sep. 2, 2021 (IT) 102021000022781

(51) Int. Cl. B01J 6/00; C01B 3/26; C01B 32/05

(52) U.S. Cl. CPC B01J 6/008; C01B 3/26; C01B 32/05; C01B 2203/0277; C01B 2203/049; C01B 2203/0816; C01B 2203/085; C01B 2203/1241; C01B 2203/1258

(57) ABSTRACT

A methane pyrolysis reactor and a methane pyrolysis method comprising the steps of: passing a natural gas stream; through a porous and permeable plate, to form natural gas bubbles; bubbling the natural gas stream through a molten metal column supported by the porous and permeable plate, to react methane to give hydrogen and carbon dioxide; separating a hydrogen gas stream; and a carbon slag; wherein the size of the pores of the porous and permeable plate is such that the capillary pressure required for the molten metal to enter the pores exceeds the bottom pressure of the molten metal column.

### TECHNICAL FIELD

The present disclosure concerns an apparatus for the pyrolysis of methane to produce hydrogen. Embodiments disclosed herein specifically concern a wellsite methane pyrolyzer and wellsite methane pyrolysis as an alternative to flaring.

### BACKGROUND ART

At present, wellsite methane, especially in remote locations, is disposed of in an inexpensive way through flaring. However, flaring produces CO₂. Simply releasing methane into the atmosphere would be even cheaper than flaring but methane is estimated to have a Greenhouse Warming Potential (GWP) that is 28-36 times worse than carbon dioxide. Therefore, direct methane release is not a suitable alternative.

Carbon dioxide (CO₂) is the most significant long-lived greenhouse gas in Earth's atmosphere. The accelerated increase of carbon dioxide concentration in the atmosphere, due to anthropogenic emissions-primarily from use of fossil fuels and deforestation—has led to global warming, the need for a reduction of carbon dioxide emissions becoming a major concern worldwide.

Typical hydrogen production also contributes to carbon dioxide emissions, being principally based on steam reforming of natural gas, this technology producing significant amounts of carbon dioxide as a byproduct. Alternative hydrogen production technologies without direct CO₂ emissions are under investigation. One way to avoid the formation of CO₂ while reforming fossil hydrocarbons for hydrogen production is the direct thermal, or thermocatalytic, decomposition, also known as cracking or pyrolysis. Thermal decomposition of natural gas, whose main component is methane, is a promising approach in this field. Furthermore, unburned natural gas may contain H₂S or other noxious gases, which are also decomposed by pyrolysis.

The methane pyrolysis reaction, as described by the simplified reaction equation

CH₄→C+2H₂

is endothermic with a standard reaction enthalpy of 74.8 KJ/mol.

High temperatures and long residence times, which favor equilibrium com-positions, reduce the probability of producing intermediates, such as ethane, ethylene and acetylene because such hydrocarbons are unstable at high temperatures. Recent pyrolyzer designs are mostly based on fluidized bed for the application of catalysts, namely metals (e.g. Ni, Fe, Cu, Co), which increase the reaction rate and enable lower reaction temperatures by decreasing the activation energy. Nevertheless, all catalysts suffer from deactivation, due to carbon deposition on the active sites or even mechanical abrasion of the catalyst. Besides the deactivation of catalysts, the formation of solid carbon during the decomposition reaction, could result in reactor clogging. An approach for the continuous decomposition of hydrocarbons, which avoids these limitations, is the utilization of liquid metals (such as molten pure Tin, Indium, Gallium, or Lead or their alloys with Nickel, Platinum, or Palladium, which can increase their catalytic activity) as a heat transfer fluid in a pyrolyzing bubble column reactor. A simple mechanistic model of the hydrocarbon bubbles is that they continuously renew their interface serving as micro reactors, releasing solid carbon particles, which float to the surface of the liquid metal, and gaseous hydrogen, which bubbles out from the top of the liquid metal column. In this way, the aforementioned disadvantages of catalytic reactor clogging can be circumvented. Floating carbon particle slag can be vacuumed off the surface of the molten metal surface as one example of carbon particle removal. Additionally, the liquid metal and/or the produced carbon could serve as a potential catalyst for accelerating the reaction.

The application of this technology presents challenges including 1) maintaining the molten metal in the reactor chamber at a temperature often higher than 1000° C. by preventing excessive heat losses out of the container, 2) continuing to heat the metal either inductively or with a hydrogen flame to replace the heat that it loses to the endothermic methane pyrolysis reaction and to heat leaks, and 3) removing and dis-posing of the resulting carbon slag, such challenges making it difficult to apply methane pyrolysis to wellsite methane, especially in remote locations.

Accordingly, an improved pyrolyzer having higher efficiency and which is more compact than systems of the current art would be beneficial and would be welcomed in the technology.

### SUMMARY

In one aspect, the subject matter disclosed herein is directed at making the reaction rates faster and the conversion of methane to hydrogen more complete by making the methane bubble sizes much smaller, which allows for a more compact design because it can utilize a shorter molten metal column. The porous and permeable plate used to support the molten metal column and to introduce natural gas into the bottom of the molten metal column allows gas to easily flow upward into the column while blocking the molten metal, and most of its heat, from flowing downward thereby reducing heat losses from the molten metal and the energy required to keep it hot.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic of a sectional view of a pyrolyzer according to a first embodiment;

FIG. 2 illustrates a schematic of a sectional view of a pyrolyzer according to a second embodiment;

FIG. 3 illustrates a schematic of a sectional view of a pyrolyzer according to a third embodiment; and

FIG. 4 illustrates a schematic of a sectional view of portion of a pyrolyzer according to a fourth embodiment.

### DETAILED DESCRIPTION OF EMBODIMENTS

According to one aspect, the present subject matter is directed to a pyrolyzer, wherein natural gas (wellsite methane) flows from below through a molten metal column to be decomposed into hydrogen and carbon. The molten metal is supported by a porous and permeable ceramic frit. The size of the pores of the ceramic frit allow natural gas to flow up through it forming bubbles as it contacts the molten metal column but, at the same time, the pores are small enough to prevent the molten metal from flowing down through it. A thermally insulating layer of ceramic microspheres is arranged below the permeable ceramic frit. Finally, another porous and permeable ceramic frit is arranged below the thermally insulating layer of ceramic microspheres, to filter out any suspended particulates in the raw natural gas.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments, the articles “a”, “an”, “the”, and “said” are intended to mean that there are one or more of the elements. The terms “comprising”, “including”, and “having” are intended to be inclusive and mean that there may be additional elements other than the listed elements.

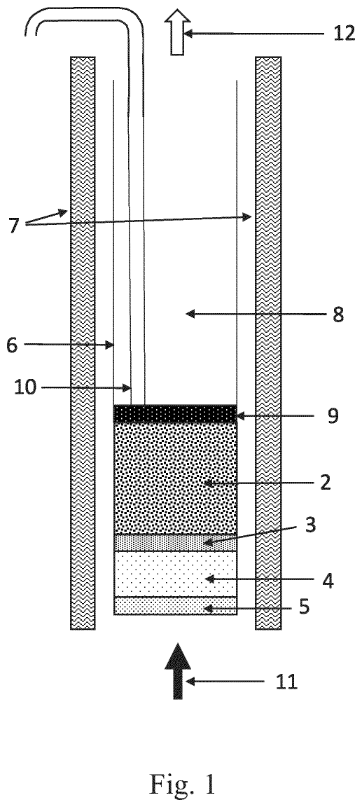

Referring now to the drawings, FIG. 1 shows a schematic of an exemplary pyrolyzer according to one embodiment of the present disclosure. In particular, in the exemplary embodiment shown in FIG. 1, a pyrolyzer 1 is shown, wherein a molten metal column 2 is supported from below by a porous and permeable plate 3, in particular a porous and permeable ceramic upper frit 3.

According to one embodiment, the temperature of the molten metal column 2 ranges between 100° and 1100° C.

The size of the pores of the ceramic upper frit 3 is such that pores are too small, by capillary pressure considerations, to let the molten metal even enter, let alone, flow through the ceramic upper frit 3. Capillary pressure equals twice the product of the interfacial tension of the molten metal (relative to natural gas) with the cosine of the contact angle (between the molten metal and the ceramic) divided by the pore radius. Liquid metals all have high surface tension in vacuum and a corresponding high interfacial tension relative to any gas. That is why it takes very high pressure to deform a liquid metal surface to make it go into a micron-size pore. That high entry pressure is likely to far exceed the column weight pressure at the bottom of any column of liquid metal that is of any reasonable height. Therefore, the liquid metal is prevented from entering the pores.

That is, the capillary pressure required for the molten metal to enter the pores of the ceramic upper frit 3 exceeds the bottom pressure of the molten metal column 2, which is given by its density times the acceleration of gravity times the column's height so it is prevented from entering the pores.

However, methane can still be pumped upward through the frit into the bottom of the molten metal over the entire large area of the ceramic upper frit 3 in the form of tiny, micron-size bubbles instead of the millimeter-size bubbles reported in the literature.

The smaller the pores of the ceramic upper frit 3, the higher the column of molten metal 2 can be without the molten metal entering the pores. Also, smaller pores make smaller methane bubbles that heat up quicker. When bubbles heat up quicker, a shorter molten metal column can be used, which allows for a more compact design. However, smaller pores imply greater methane pressure drop across the ceramic upper frit 3, reducing gas flow so there is a practical limit and a tradeoff in minimum pore size.

In an exemplary embodiment, a 10 μm pore size (as Coor's P-10-C), could support a 70-inch high molten metal column 2, which is probably much taller than a column according to the present disclosure would actually be in practice.

According to the embodiment of FIG. 1, to reduce the downward heat loss, the ceramic upper frit 3 sits upon a thermally insulating layer 4 of high temperature, hollow, ceramic microspheres. This hollowness results in low mass density, low thermal conductivity, a closed surface, and low heat capacity. The spherical shape ensures iso-tropic properties and low surface to volume ratio. An exemplary ceramic microsphere material can be aluminosilicate or amorphous aluminum phosphate or borosilicate glass. The micro-bubbles should have as low a thermal conductivity as possible. In an exemplary embodiment, the ceramic microspheres are K1 (65 micron) and S15 (55 micron), both produced by 3M, which have only about twice the thermal conductivity of still air. Within each 3M series, the thermal conductivity increases with decreasing micro-bubble size so the larger size micro-bubbles are preferred.

Finally, this layer 4 of hollow ceramic microspheres sits on top of a second porous and permeable plate 5, in particular a porous and permeable ceramic lower frit 5 that filters out particulates within the raw natural gas that is pumped upward through it. The pores of the ceramic lower frit 5 can be much larger than the pores of the ceramic upper frit 3 as they are only used as a coarse particulate filter.

The molten metal column is contained laterally by a container 6 preferably made of a high temperature solid metal such as steel, which has a melting point of 1370° C. A Dewar Flask is arranged around the steel container to avoid heat losses. The walls 7 of the Dewar Flask are made of a highly insulating material, preferably FRCI from Orbital Ceramics, Forrest Machining Inc., which is similar to the thermal tiles used to protect space vehicles as they reenter the earth's atmosphere.

Heat loss from the upper part of a Dewar Flask is considerably reduced by limiting the height of the hot liquid molten metal column to less than one third of the total height of the Dewar Flask. According to the exemplary embodiment of FIG. 1, a head space 8 is shown above the molten metal column 2.

A carbon slag layer 9 forms above the molten metal column 2 because carbon density is much lower than the liquid metal density. A vacuum line 10 is present for occasionally suctioning out carbon slag from the top of the molten metal column 2.

According to the embodiment of FIG. 1, the pyrolyzer 1 operates as follows. A natural gas stream 11 enters the pyrolyzer 1 from the bottom, first passing through the ceramic lower frit 5, wherein any particulates are removed from the natural gas stream through filtering. The natural gas stream subsequently passes through the thermally insulating layer 4 of ceramic microspheres and the porous and permeable ceramic upper frit 3, wherein it is divided into small, micron-size bubbles, with a diameter of one-tenth mm or less. The micron-size bubbles pass through the molten metal column 2, heating up almost instantly to the surrounding fluid temperature. Even though the thermal conductivity of any gas is low, these micron-size bubbles allows almost instant transfer of heat and immediate temperature equilibration all the way to the bubble centers. As a consequence, the pyrolysis reaction rate is correspondingly increased. The solid carbon and gaseous hydrogen formed as products of the pyrolysis reaction are released on top of the liquid metal column, with the tiny carbon soot particles forming a layer 9 floating on top of the liquid metal surface due to density differences.

The methane pyrolysis reaction, being an endothermic reaction, needs heat to be provided to the molten metal column to maintain the correct temperature. Part of produced H₂ can be burned according to the following reaction (ΔH₀=−486 KJ/mol)

2H₂+O₂→2H₂O

to provide heat to the molten metal column. Being a highly exothermal reaction, the burning of 15% of produced H₂ can provide enough heat to continue the decarbonization reaction.

A hydrogen gaseous stream 12 outflows the pyrolyzer 1 from the top. Hydrogen so produced can be used to feed internal combustion engines, or fuel cells, to generate electricity.

Carbon soot can be removed from the top of the molten metal column 2 and sold to tire or other industries.

In some embodiments, solar energy could be used to make electricity to heat the molten metal, or, with a high enough solar concentrator, to heat, or assist in heating, the molten metal directly.

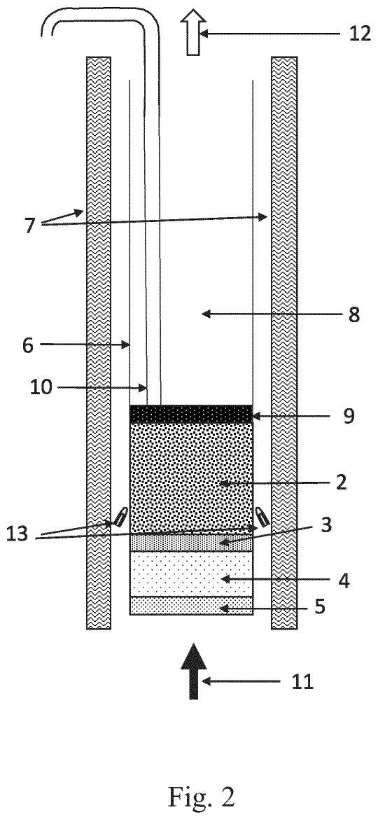

With continuing reference to FIG. 1, a further embodiment of the pyrolyzer according to the present disclosure is shown in FIG. 2. The same reference numbers designate the same or corresponding parts, elements or components already illustrated in FIG. 1 and described above, and which will not be described again. In this embodiment, in order to provide heat to the molten metal column 2, flame nozzles 13 can be arranged around the molten metal column 2.

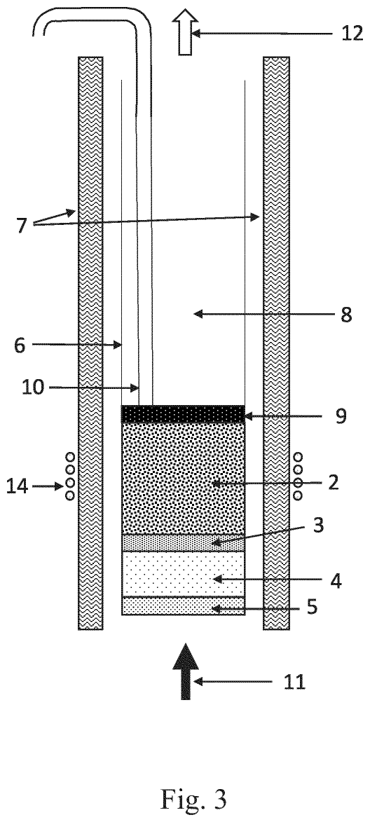

With continuing reference to FIGS. 1 and 2, a further embodiment of the pyrolyzer is shown in FIG. 3. The same reference numbers designate the same or corresponding parts, elements or components already illustrated in FIGS. 1 and 2 and described above, and which will not be described again. In particular, according to this embodiment, coils 14 for inductive heating of molten metal can be used.

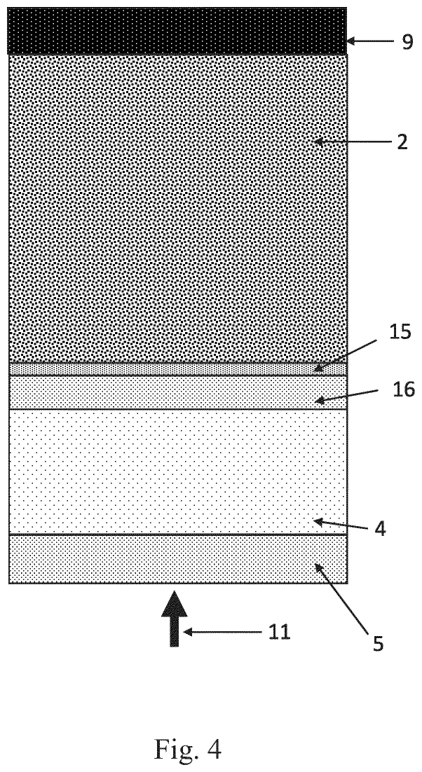

In yet further embodiments, reference being made in particular to FIG. 4, in order not to excessively increase pressure drop when pumping methane through the ceramic upper frit 3 while maintaining small pore size to form small bubbles, the ceramic upper frit 3 is divided into a thin veneer of the finest pore size frit 15 on top of a thicker section of a larger pore size frit 16. According to one embodiment, the veneer of finest pore size frit 15 can be P-1/2-AC (0.5 micron pores) from Coors. So, for the upper frit, pore sizes can range from one-half micron, when the ceramic upper frit 3 is divided into a veneer of finest pore size frit 15 on top of a larger pore size frit 16 (up to 10 microns), when the ceramic upper frit 3 is made of a single material.

In yet other embodiments, not shown, to have even more surface area in contact with the molten metal column 2, the bottom frit can extend around in a cup shape instead of simply being a flat, horizontal disk at the column's bottom.

While the invention has been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

1. A methane pyrolysis reactor comprising,
a container:
a porous and permeable plate arranged in the lower part of the container;
at least one natural gas stream inlet arranged below the porous and permeable plate, and,
at least one hydrogen product stream outlet; arranged at the top of the reactor,
wherein the porous and permeable plate is adapted to allow the passage of the natural gas stream and to support a molten metal column between the porous and permeable plate; and a head space on the upper part of the container, and
wherein the size of the pores of the porous and permeable plate is such that the capillary pressure required for the molten metal to enter the pores exceeds the bottom pressure of the molten metal column.

2. The methane pyrolysis reactor of claim 1, further comprising a suctioning line on the top of the molten metal column.

3. The methane pyrolysis reactor of claim 1, further comprising a thermally insulating layer, below the porous and permeable plate, adapted to allow the passage of the natural gas stream.

4. The methane pyrolysis reactor of claim 3, further comprising a second porous and permeable plate, below the thermally insulating layer, adapted to filter out particulates from the natural gas stream and to allow the passage of the natural gas stream.

5. The methane pyrolysis reactor of claim 1, further comprising a Dewar Flask arranged around the container.

6. The methane pyrolysis reactor of claim 1, further comprising flame nozzles arranged around the container and the molten metal column.

7. The methane pyrolysis reactor of claim 1, further comprising coils for inductive heating arranged around the container and the molten metal column.

8. The methane pyrolysis reactor of claim 16, wherein the porous and permeable plate is divided into a thin veneer of a finer pore size plate on top of a thicker section of a larger pore size plate.

9. A method for methane pyrolysis; the method comprising the steps of:
passing a natural gas stream through a porous and permeable plate, to form natural gas bubbles;
bubbling the natural gas stream through a molten metal column; supported by the porous and permeable plate, to react methane to give hydrogen and carbon dioxide; and, separating a hydrogen gas stream and a carbon slag,
wherein the size of the pores of the porous and permeable plate is such that the capillary pressure required for the molten metal to enter the pores exceeds the bottom pressure of the molten metal column.

10. The method of claim 9, wherein the step of separating carbon comprises suctioning the carbon from a carbon slag layer above the molten metal column.

11. The method of claim 9, further comprising the step of filtering the natural gas stream upstream the porous and permeable plate.
